(19) United States
(12) Patent Application Publication
(10) Pub. No.: US 2026/0036158 A1
(43) Pub. Date: Feb. 5, 2026

(54) FASTENER ASSEMBLY HAVING FLUSH FACED WORKING PORTION

(71) Applicant: Screw This Screw That LLC, Daytona Beach, FL (US)

(72) Inventors: Brandon A. Serle, Daytona Beach, FL (US); Jeffrey Q. Serle, Flagler Beach, FL (US)

(21) Appl. No.: 19/357,347

(22) Filed: Oct. 14, 2025

Related U.S. Application Data
(63) Continuation of application No. PCT/US24/14960, filed on Feb. 8, 2024.
Application No. PCT/US24/14960 is a continuation-in-part of application No. 18/136,094, filed on Apr. 18, 2023.

(51) Int. Cl. F16B 23/00

(52) U.S. Cl. CPC F16B 23/0038

(57) ABSTRACT

A fastener assembly includes a shank having a threaded portion for guiding the fastener assembly into a correspondingly threaded portion of another fastener or a working surface and a head engaged with the shank for receiving a tool. The head defines a cutout for receiving an insert. The insert is configured for translation within the cutout along a longitudinal axis such that the insert can be depressed downward upon insertion of a tool and then biased upward when the tool is removed, thus providing a smooth-faced flush mount fastener.

### CROSS-REFERENCE TO RELATED APPLICATIONS

This application is a continuation of PCT Patent Application No. PCT/US24/14960, titled “FASTENER ASSEMBLY HAVING FLUSH FACED WORKING PORTION” filed on Feb. 8, 2024, which is a continuation-in-part of U.S. patent application Ser. No. 18/136,094, titled “Fastener Assembly Having Flush Faced Working Portion” filed on Apr. 18, 2023, which are incorporated herein in their entireties by this reference.

### TECHNICAL FIELD

The present invention relates generally to a fastener assembly having a flush faced or smooth head fastener that has a hidden allen or other key hole that appears when it is depressed into the face.

### BACKGROUND

Fasteners typically have a shank and a working head attached to the shank. The shank is threaded, and rotational movement of the shank via a tool rotating the working head causes longitudinal movement of the fastener within a correspondingly threaded second fastener or working surface.

The working head though is almost always either exposed for above-surface fasteners such as a bolt with a hex head, or below surface for a countersunk fastener that receives a tool within a recess of the head. However, this countersunk fastener leaves the recess exposed.

There is a need for flush face/smooth head fasteners in various industries. For example, in the pharmaceutical field, there is a need for a fastener with no indents on the head, for example, for a so-called Phillips head, slot head, and internal hex head that facilitates and aids in good cleaning practices. Bacteria and organic matter can grow in places that are not regularly cleaned or wiped down. A flush fastener eliminates the need to use special tools to clean crevices created from indents in fasteners. These crevices are typically too small for mechanical cleaning which will allow for contamination to build up. The flush face and smooth head fasteners allows the screws to be used in environments that must remain sterile or be made aseptic. These uses could be, for example, in laboratories, clean rooms, and surgical suites.

Additionally, in the Aerospace field, there is a need for a fastener that minimizes drag in aircraft. Indents in the current fasteners on the market today induce extra drag on surfaces. A flush fastener will eliminate the extra drag cause from the crevices in the heads of standard fasteners.

These and other disadvantages are addressed by the disclosure provided herein.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

Embodiments according to the invention can provide a fastener assembly having a flush faced or smooth head fastener that has at least one hidden allen or other key hole(s) that appear when depressed into the face of the fastener.

According to one or more embodiments, a fastener assembly includes a body and an insert. The body comprises a shank having a threaded portion for guiding the fastener assembly into a correspondingly threaded portion of another fastener or a working surface, and a head engaged with the shank for receiving a tool. The head defines at least one cutout for receiving an insert. The insert is compressible and configured for translation within the housing along a longitudinal axis. When compressed, the insert defines a recess for receiving the working end of a tool. In some embodiments, the insert may be adapted to limit upward movement along the longitudinal axis in order to secure the insert within the fastener.

According to one or more embodiments, the head includes more than one cutout or at least one custom shaped cutout for receiving the working end of a custom tool.

According to one or more embodiments, the fastener assembly further includes a biasing member between the insert and a surface of the cutout for biasing the insert in an upward direction relative to the longitudinal axis.

According to one or more embodiments, the insert comprises a first surface and an opposing second surface. The first surface preferably is aligned with the top surface of the head when the insert is biased upwardly, and the bottom surface of the insert comes in contact with the biasing member. The first surface of the insert preferably corresponds to the shape of the working end of a tool.

According to one or more embodiments, the biasing member is a spring.

According to one or more embodiments, the biasing member is a magnet.

According to one or more embodiments, the second surface of the insert defines a recessed seat for receiving an upward end of the spring, and the shank defines a recessed seat for receiving a downward end of the spring.

According to one or more embodiments, the insert comprises a housing for being fit into the cutout and a compressible fastener plunger. The housing may include an inwardly extending shoulder that engages an outwardly extending shoulder on the compressible fastener plunger to provide interfering engagement to limit upward movement along the longitudinal axis.

According to one or more embodiments, the fastener assembly further includes a biasing member between the compressible fastener plunger and a surface of the cutout for biasing the compressible fastener plunger in an upward direction relative to the longitudinal axis.

According to one or more embodiments, a top surface of the compressible fastener plunger is aligned with a top surface of the head when the compressible fastener plunger has been biased upwardly.

According to one or more embodiments, the housing is press fit into the cutout.

According to one or more embodiments, the recess defined by the compressible fastener plunger is a hex shaped recess.

According to one or more embodiments, the fastener includes a pin that is received within an opening defined in the housing and the head of the shank for prohibiting rotation of the housing relative to the shank.

According to one or more embodiments, the shank of the fastener defines a recess that extends through the bottom of the shank, whereby the insert and biasing member may be inserted through the bottom of the fastener.

According to one or more embodiments, the body of the fastener is divided into separate halves that press fit together to either lock or snap in place, whereby the insert may be positioned between the two halves and secured in place inside the fastener when the separate halves are pressed together.

According to one or more embodiments, a dowel may be inserted laterally through the shank of the fastener to engage the insert, thus limiting the upward movement of the insert.

### BRIEF DESCRIPTION OF THE DRAWINGS

The foregoing, as well as the following Detailed Description, is better understood when read in conjunction with the appended drawings. For the purposes of illustration, there are shown in the drawings exemplary embodiments; however, the presently disclosed subject matter is not limited to the specific methods and instrumentalities disclosed.

The embodiments illustrated, described, and discussed herein are illustrative of the present invention. As these embodiments of the present invention are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

FIG. 1 illustrates a perspective view of a fastener assembly where the fastener assembly is illustrated with a flushed face working surface.

FIG. 2 illustrates a perspective view of the fastener assembly of FIG. 1 where the fastener assembly is illustrated with a recessed working surface.

FIG. 3A illustrates a perspective view of an embodiment of the fastener assembly where the insert comprises a housing and a compressible fastener plunger and where a magnet provides biasing forces to bias the working surface of the fastener to the flushed face arrangement of FIG. 1.

FIG. 3B is a cross-sectional view of the embodiment illustrated in FIG. 3A.

FIG. 3C is a front facing view of the embodiment of the fastener assembly of FIG. 3A, where the fastener assembly is shown against a working surface that receives the fastener assembly.

FIG. 3D is a front facing, cross-sectional view of the view of FIG. 3C where the fastener assembly is shown against another fastener that receives the fastener assembly.

FIG. 4A illustrates a perspective view of an embodiment of the fastener assembly where a spring provides biasing forces to bias the working surface of the fastener to the flushed face arrangement of FIG. 1.

FIG. 4B is a cross-sectional view of the embodiment illustrated in FIG. 4A.

FIG. 4C is a front facing view of the embodiment of the fastener assembly of FIG. 4A.

FIG. 4D is a front facing, cross-sectional view of the view of FIG. 4C.

FIG. 5 illustrates a perspective view of an embodiment of the fastener assembly where the housing covers the head of the fastener, and a spring provides biasing forces.

FIG. 6A. illustrates a perspective view of an embodiment of the fastener assembly where a dowel may engage the insert to limit upward movement.

FIG. 6B is a perspective view of the embodiment illustrated in FIG. 6A showing where the dowel may be inserted into the body of the fastener.

FIG. 6C is a cross-sectional view of the embodiment illustrated in FIGS. 6A and 6B.

FIG. 7A is a cross-sectional view of an embodiment of the fastener illustrating the shank defining a recess wherein the insert, a biasing member, and a plug may be inserted.

FIG. 7B is a cross-sectional view of the embodiment illustrated in FIG. 7A showing the insert, biasing member, and plug being fully inserted in the body of the fastener.

FIG. 7C is a top view of the embodiment of the fastener of FIGS. 7A and 7B.

FIG. 7D is a bottom view of the embodiment of the fastener of FIGS. 7A and 7B.

FIG. 8A is a cross-sectional, exploded view of an embodiment of the fastener illustrating the body divided into separate halves that may be fitted together around the insert.

FIG. 8B is a cross-sectional view of the embodiment of FIG. 8A, whereby the fastener is assembled together.

FIG. 8C is a cross-sectional view of the embodiment of the fastener of FIG. 8B illustrating an alternative form of engaging the insert to limit upward movement.

FIG. 8D is a top view of the embodiment of the fastener of FIGS. 8A, 8B, and 8C.

FIG. 8E is a bottom view of the embodiment of the fastener of FIGS. 8A, 8B, and 8C.

FIG. 9A is a perspective view of an embodiment of the fastener illustrating more than one cutout and more than one insert.

FIG. 9B is a cross-sectional view of the embodiment of the fastener of FIG. 9A.

### DETAILED DESCRIPTION

The following description and figures are illustrative and are not to be construed as limiting. Numerous specific details are described to provide a thorough understanding of the disclosure. In certain instances, however, well-known or conventional details are not described in order to avoid obscuring the description. Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

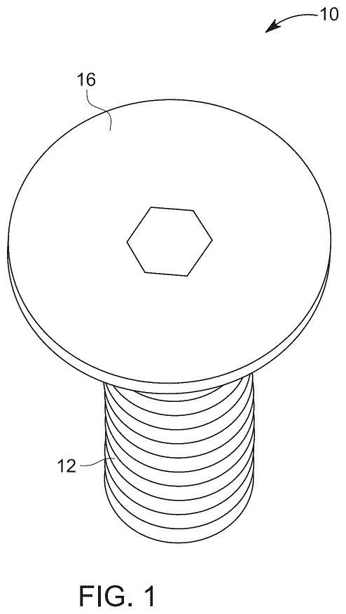

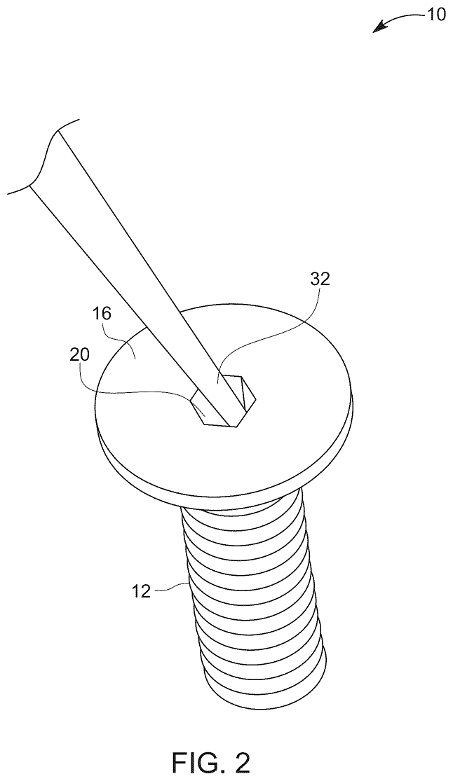

FIG. 1 illustrates a perspective view of an exemplary embodiment of a fastener assembly where the fastener assembly is illustrated with a flushed face working surface. The fastener assembly is generally designated as 10 throughout the drawings. FIG. 2 illustrates a same general perspective view as shown in FIG. 1, however, here the fastener assembly 10 is shown with a recessed working surface in response to a tool or other device pressing downwardly on an insert within the head that will be described further herein. This arrangement allows for a flush faced head fastener described herein that addresses the disadvantages associated with conventional recessed head fasteners. In this figure, the head of the fastener illustrates a hexagonal cutout, but it is to be understood that the cutout may be any appropriate shape or number capable of receiving a corresponding tool.

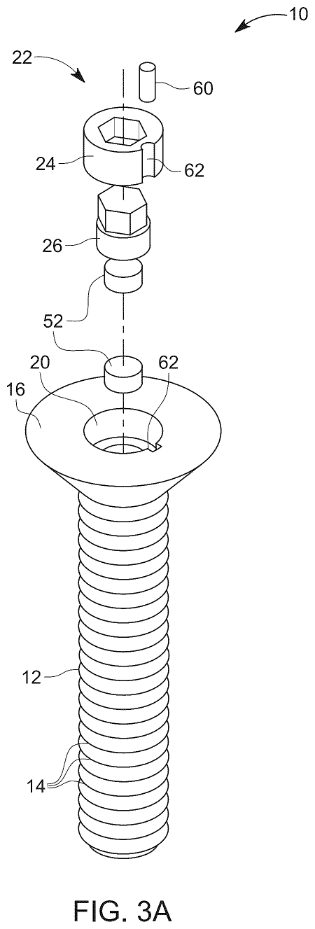

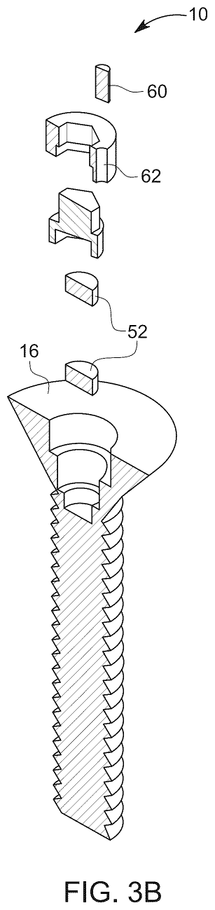

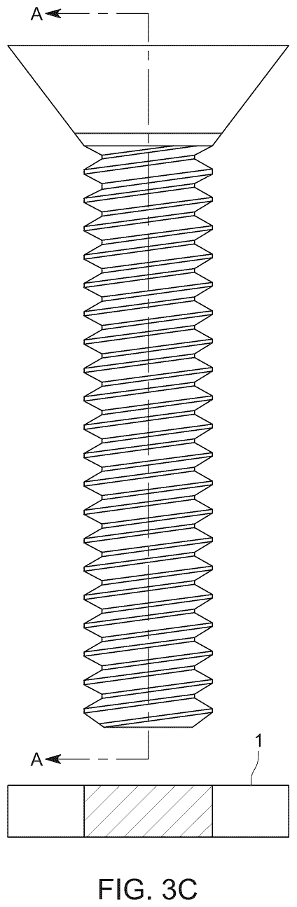

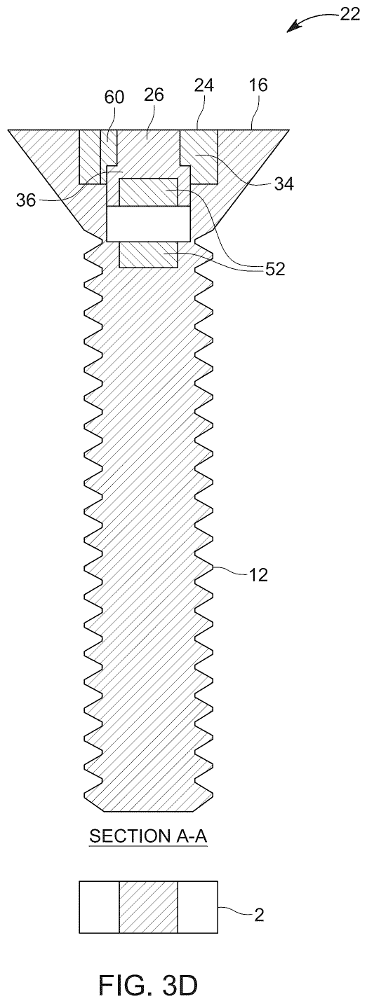

The fastener assembly 10 includes a body comprising a shank 12 having a threaded portion 14 for guiding the fastener assembly 10 into a correspondingly threaded portion 2 of another fastener (as illustrated in FIG. 3D) or a working surface (as illustrated in FIG. 3C). The threaded portion 14 is preferably a conventional threaded portion and may be right or left hand threaded, or any other appropriately configured threaded assembly. The body of the fastener assembly 10 also includes a head 16 engaged with the shank 12 for receiving a tool. A tool 32 is generally represented in FIG. 2, however, any appropriately configured tool may be used. The fastener assembly 10 may be any length, width, size, etc. as desired. In the accompanying drawings, the head is illustrated as having a wider diameter that tapers to the shank; however, it is to be understood that the head and shank may be fashioned in any shape and/or diameter as needed or desired. The fastener assembly 10 also comprises an insert 22 and a means for translational movement of the insert 22 along a longitudinal axis, preferably provided by a biasing member discussed further herein. However, it is also contemplated that the insert itself may comprise a means for translational movement negating the need for a separate biasing member. For example, the insert 22 may be constructed of an elastomer material that is capable of being compressed under force (such as the insertion of a tool) and then rebounds or returns to its original shape once the force has been removed.

The head 16 defines at least one cutout 20 for receiving an insert 22. The insert is preferably configured for receiving the working end of a tool and is compressible along a longitudinal axis. In one or more embodiments, the insert 22 may comprise a housing 24 for being fit into the cutout 20 and a separate compressible fastener plunger 26 that fits within the housing 24. In this arrangement, the housing 24 preferably secures the insert 22 within the head 16, and the compressible fastener plunger 26 is configured to receive the working end of a tool 32. In one or more embodiments, the housing 24 is press fit into the cutout 20, whereas, in other embodiments, the housing 24 can be welded, glued, or otherwise secured to the head 16. In alternative embodiments, the insert 22 may be a single member that is shaped to fit within the fastener assembly 10 and is configured for translation along a longitudinal axis.

As illustrated in the accompanying figures, an insert 22 is positioned within the head 16. When depressed, the insert 22 defines a recess 30 for receiving the working end of a tool 32. As illustrated, the recess 30 can be a hex head recess, i.e. a so-called allen head, though other shapes such as a Phillips, square security, Torx® head, or any other shape may be employed. The insert 22 is configured for translation within the housing 24 along a longitudinal axis. This translation provides the ability for the head to be a flush mount as shown in FIG. 1, and then depressed to allow for receipt and insertion of a working tool as shown in FIG. 2. For example, a user would position the working end of a tool over the cutout in the head of the fastener and insert the tool into the cutout, thereby depressing the insert within the cutout. As the insert is depressed or biased downwardly, the user can screw the fastener in place. Once the tool is removed, the insert is biased upwardly and sits at rest, flush against the head of the fastener thereby forming a smooth surface of the fastener.

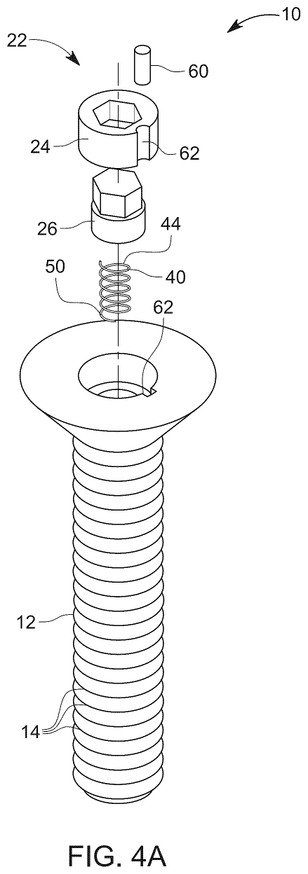

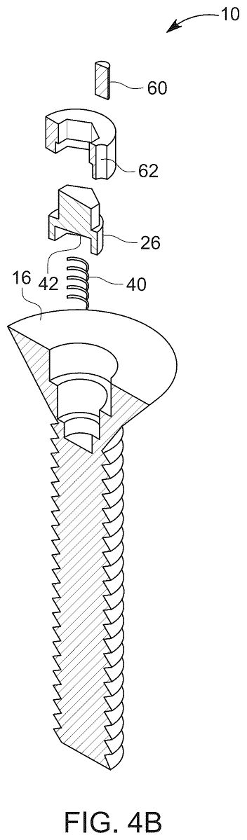

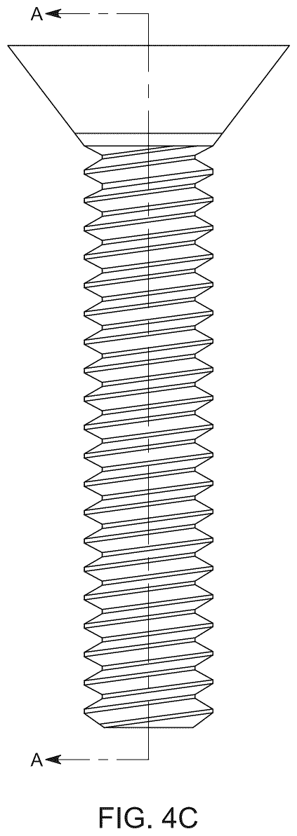

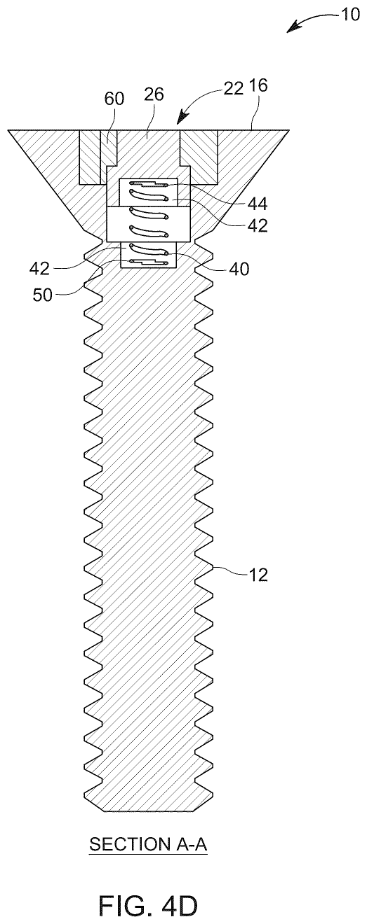

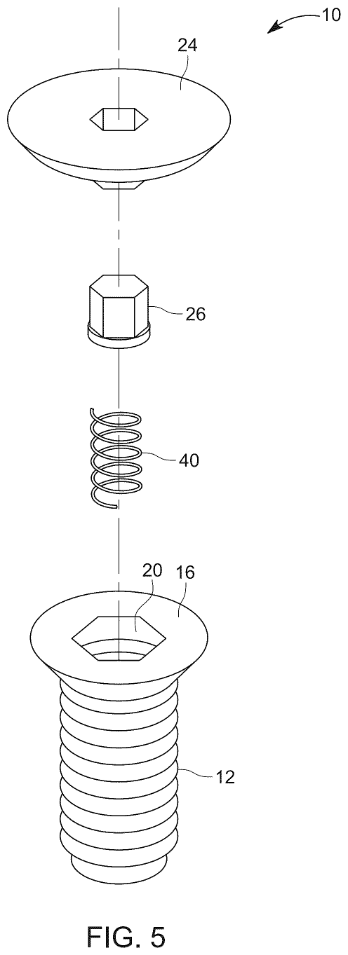

As illustrated in FIG. 3A and FIG. 3B, one embodiment of the fastener assembly includes an insert that comprises a housing 24 that fits over a compressible fastener plunger 26, securing the compressible fastener plunger 26 within the fastener 10. To assemble the fastener of this embodiment, it is contemplated that the compressible fastener plunger 26 would be inserted into the cutout 20 of the fastener, followed by insertion of the housing 24 over at least a portion of the compressible fastener plunger 26. In one or more embodiments, the housing 24 may be adapted to fit fully inside the cutout, as illustrated in FIGS. 3A and 4A. In one or more alternative embodiments, the housing 26 may be adapted to fit partially inside the cutout while a top surface of the housing 26 covers the top surface of the head 16, as illustrated by FIG. 5. In this arrangement, the housing 24 preferably press fits over at least a portion of the compressible fastener plunger 26, and the top surface of the housing 24 covers the surface of the head 16, rather than fitting fully inside the cutout 20.

As illustrated in FIG. 3D, the housing 24 may interferencingly engage the compressible fastener plunger 26 to limit upward movement along the longitudinal axis. In a preferred embodiment, the upward movement is in response to forces applied from a biasing member, which will be described further herein. The upward movement provides the fastener assembly 10 to have a flush faced arrangement as shown in FIG. 1 as an initial, or at rest arrangement. The biasing force provided is thus less than or is able to be overcome by the downward force provided by the working tool so that the compressible fastener plunger 26 can be depressed. In one embodiment, the interferencing engagement may be provided by an inwardly extending shoulder 34 of the housing 24 that engages an outwardly extending shoulder 36 on the compressible fastener plunger 26 to limit upward movement along the longitudinal axis.

According to one or more embodiments as shown in FIG. 4A, the biasing member may be a spring 40 between the compressible fastener plunger 26 and a surface of the cutout for biasing the compressible fastener plunger 26 in an upward direction relative to the longitudinal axis. In one embodiment, the compressible fastener plunger 26 defines a recessed seat 42 for receiving an upward end 44 of the spring 40. This is well-illustrated throughout the various versions of FIG. 4, particularly FIG. 4D. The shank 12 may further define a recessed seat 42 for receiving a downward end 50 of the spring 40. The spring 40 thus provides biasing forces to bias the compressible fastener plunger 26 in an upward direction to provide for the flush faced arrangement as shown in FIG. 1.

According to another embodiment, the biasing member may be a magnet 52 or pair of magnets positioned to oppose one another. This is well-illustrated in FIG. 3A. The magnet may be any appropriately configured magnet and may be recessed within a seat 42 or similar arrangement within the cutout 20 of the head 16 and/or shank 12 to provide a biasing force.

In yet another embodiment, the biasing member may be an elastomer or another suitable rubber-like compound that is capable of being compressed or stretched under force and then rebounds or returns to its original shape once the force has been removed.

Referring back to FIG. 3A, in one or more embodiments, a pin 60 may be received within an opening 62, where opening 62 is defined in the head 16 and insert 22. The pin 60 may be removable, or it may be press fit therein, and is configured to prohibit rotation of the housing 24 relative to the shank 12.

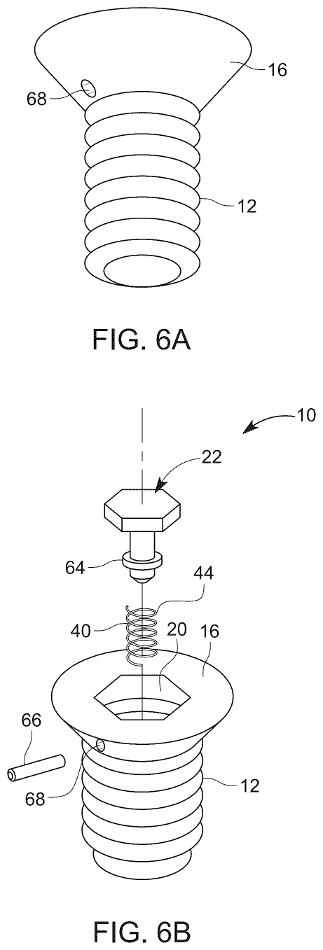

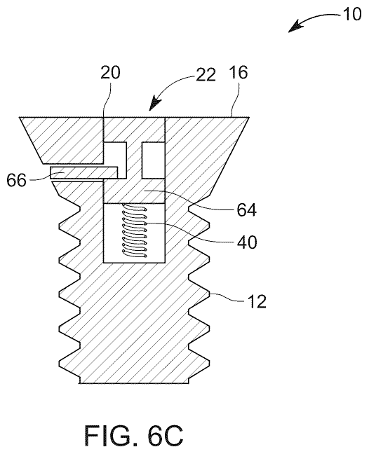

In one or more embodiments, the insert 22 may be a member configured to fit within the fastener assembly 10 and provide translational movement along a longitudinal axis. FIGS. 6A and 6B illustrate an insert 22 that includes a top surface corresponding to the shape of and fitting within the cutout 20, and a shelf 64 that extends radially from the body of the insert 22. In this embodiment, a first surface of the radially extending shelf 64 engages a biasing member, in this case the upward end 44 of a spring 40, thereby biasing the insert 22 in an upward direction relative to the longitudinal axis while still allowing for translational movement and compression upon the insertion of a tool. As shown in FIG. 6C, a second surface of the radially extending shelf engages a dowel 66 that may be inserted laterally into an opening 68 the body of the fastener assembly 10 and interfaces with the shelf 64, thereby limiting the upward movement of the insert 22 and securing the insert 22 within the head 16 while still allowing for compression and translational movement along the longitudinal axis.

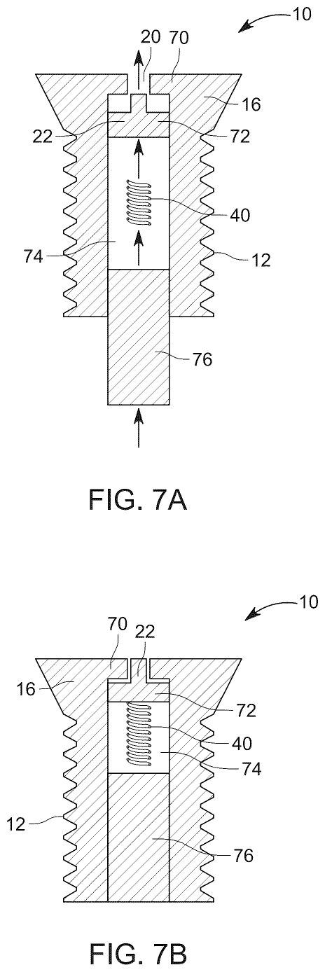

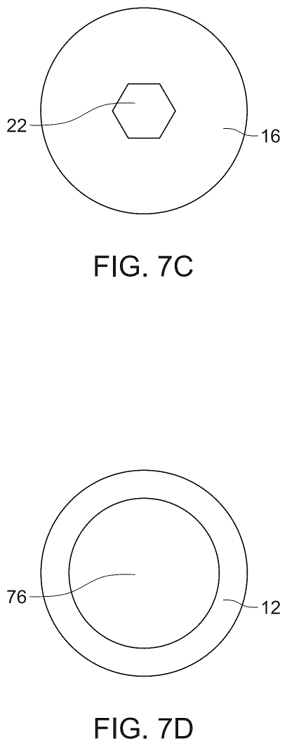

In one or more embodiments, the fastener assembly 10 may define a recess 74 that runs the longitudinal length of the fastener body, as illustrated in FIGS. 7A and 7B, thereby forming a hollow interior of the fastener body. This recess 74 allows the insert 22 and biasing member (if needed) to be inserted through the bottom of the shank 12 of the fastener 10 until the insert 22 reaches the head 16 of the fastener 10. In this embodiment, the head 16 and the insert 22 are configured to engage one another to limit upward and outward movement of the insert 22 from the body of the fastener 10. For example, in FIG. 7B, the inner circumference of the cutout 20 of the head 16 has a lip 70 extending outward that engages a lip 72 extending outward from the insert 22. In this way, the insert 22 may still be depressed in a downward direction, but is prevented from full upward and outward movement from the cutout 20 of the fastener 10. In FIG. 7A, after the insert 22 and the biasing member are slid into the fastener 10, a plug member 76 may then be inserted behind the insert 22 to secure the insert 22 and biasing member inside the fastener 10. In one or more embodiments, the plug member 76 may be press fit into the shank 12; in other embodiments, the plug member 76 may be welded, glued, or otherwise secured within the shank 12. In further embodiments, the plug member 76 may include a lip extending radially from the bottom of the plug and configured to engage, attach to, or cover the bottom surface of the fastener shank 12, thereby preventing the plug member 76 from being inserted deeper into the recess 74 than what is necessary or desired. FIG. 7C illustrates an embodiment of the top of the fastener assembly 10 with the insert 22 flush with the head 16, and FIG. 7D shows an embodiment of the bottom of the fastener assembly 10 illustrating the hollow recess 74 with the plug member 76 inserted.

It is to be understood that the insert 22 and the recess 74 of the fastener assembly 10 may be configured in any shape, (such as generally cylindrical in shape, generally prismatic such as a hexagonal prism, generally cuboidal, etc.) provided that the geometry corresponds in such a way whereby the insert 22 can slide into the recess 74 and receive the working end of a tool.

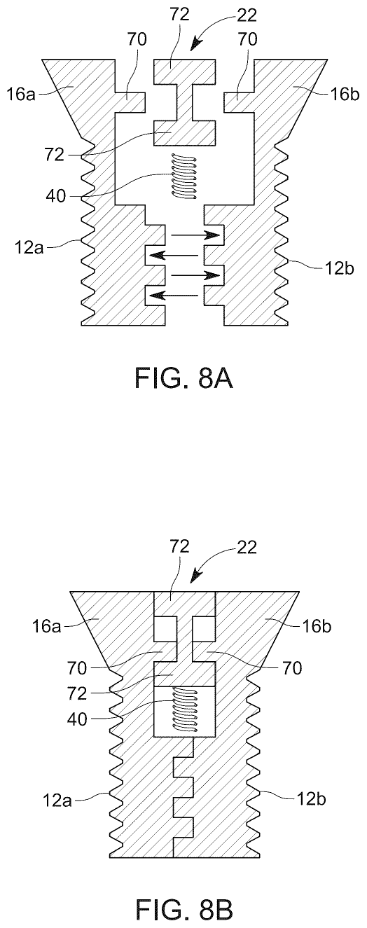

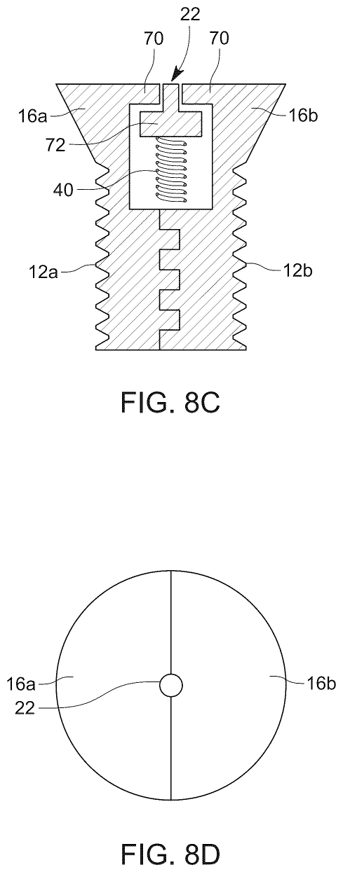

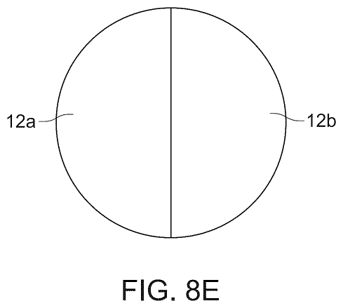

In one or more embodiments shown in FIGS. 8A-8C, the body of the fastener assembly 10 is comprised of two halves (16a, 16b, and 12a, 12b) that fit together in a snap-fit, press fit, or any other suitable interlocking manner. Alternatively, the halves may be welded, glued, or otherwise secured together following assembly of the fastener 10. In this arrangement, rather than being inserted into the cutout 20 from the top of the fastener 10 or slid within the shank 12 of the fastener 10, the insert 22 is enclosed within the cutout 20 of the head 16 during assembly of the fastener 10. During assembly of this embodiment, it is contemplated that the insert 22 (and biasing member, if included) would be placed within the cutout 20 between the two separated halves (16a, 16b and 12a, 12b) of the fastener body, and the halves of the fastener body would be pressed, snapped, or otherwise attached together; thereby securing the insert 22 (and biasing member, if included) within the fastener 10. In this embodiment, the head 16 and insert 22 of the fastener 10 are configured to engage one another in such a way that translational movement of the insert 22 along the longitudinal axis is allowed, while the upward movement of the insert is limited to secure the insert 22 within the fastener 10. For example, a lip 70 may extend from the interior circumference of the cutout 20 in the head 16 of the fastener 10, thereby engaging a corresponding lip 72 extending from the body of the insert 22. FIGS. 8A and 8B illustrate an embodiment whereby the insert 22 may be spool-shaped with an upper lip 72 and lower lip 72 adapted to engage a corresponding lip 70 extending from a mid-location of the interior circumference of the cutout 20. FIG. 8C illustrates an embodiment whereby the insert 22 has a lower lip 72 adapted to engage a corresponding lip 70 extending from the upper portion of the interior circumference of the cutout 20. FIGS. 8D and 8E illustrate a top and bottom view, respectively, of this embodiment of the fastener assembly.

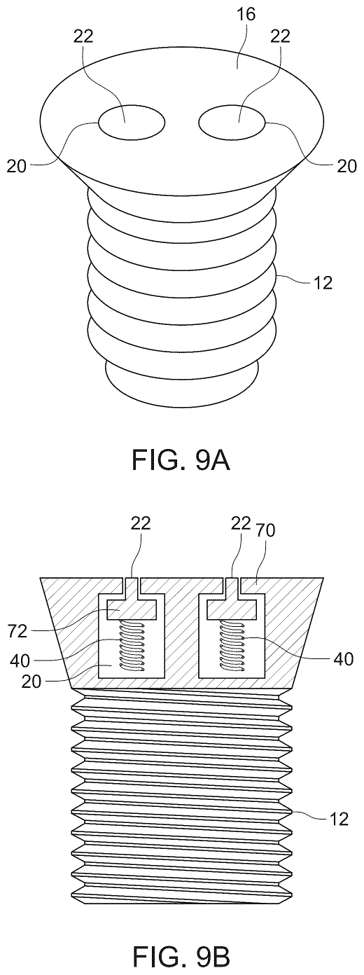

As illustrated in FIGS. 9A and 9B, the fastener assembly 10 may include more than one cutout 20 to receive the working end of a custom tool. The fastener assembly 10 may be fashioned in the same arrangements and embodiments described herein, with each cutout 20 having an insert 22 configured for translational movement along the longitudinal axis. In FIG. 9A, two circular cutouts 20 are shown, but it is to be understood that the shape and number of cutouts 20 may vary dependent upon the type of tool being used with the fastener assembly 10.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way.

Alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure.

As will be described in greater detail below with reference to the figures, the subject matter described herein provides

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive subject matter. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that when an element or layer is referred to as being “on” another element or layer, the element or layer can be directly on another element or layer or intervening elements or layers may also be present. In contrast, when an element is referred to as being “directly on” another element or layer, there are no intervening elements or layers present. As used herein, the term “and/or” includes any and all combinations of one or more of the associated listed items.

Spatially relative terms, such as “below”, “beneath”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. Throughout the specification, like reference numerals in the drawings denote like elements.

Embodiments of the inventive subject matter are described herein with reference to plan and perspective illustrations that are schematic illustrations of idealized embodiments of the inventive subject matter. As such, variations from the shapes of the illustrations as a result, for example, of manufacturing techniques and/or tolerances, are to be expected. Thus, the inventive subject matter should not be construed as limited to the particular shapes of objects illustrated herein, but should include deviations in shapes that result, for example, from manufacturing. Thus, the objects illustrated in the figures are schematic in nature and their shapes are not intended to illustrate the actual shape of a region of a device and are not intended to limit the scope of the inventive subject matter.

The terminology used herein is for the purpose of describing particular embodiments only and is not intended to be limiting of the present inventive subject matter. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present inventive subject matter belongs. It will be further understood that terms used herein should be interpreted as having a meaning that is consistent with their meaning in the context of this specification and the relevant art and will not be interpreted in an idealized or overly formal sense unless expressly so defined herein. The term “plurality” is used herein to refer to two or more of the referenced item. Although any methods, devices, and materials similar or equivalent to those described herein can be used in the practice or testing of the presently disclosed subject matter, representative methods, devices, and materials are now described.

In the drawings and specification, there have been disclosed typical preferred embodiments of the inventive subject matter and, although specific terms are employed, they are used in a generic and descriptive sense only and not for purposes of limitation, the scope of the inventive subject matter being set forth in the following claims.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A fastener assembly comprising:
a body comprising a shank having a threaded portion for guiding the fastener assembly into a correspondingly threaded portion of another fastener or a working surface and a head engaged with the shank for receiving a tool;
wherein the head defines at least one cutout for receiving an insert;
wherein the insert is configured for translation within the cutout along a longitudinal axis; and
wherein a top surface of the insert is aligned with a top surface of the fastener assembly when the insert has been biased in upwardly.

2. The fastener assembly of claim 1 wherein the insert interferencingly engages the cutout to limit upward movement along the longitudinal axis.

3. The fastener assembly of claim 1, further including a biasing member between the insert and a surface of the cutout for biasing the insert in an upward direction relative to the longitudinal axis.

4. The fastener assembly of claim 3, wherein the biasing member is a spring.

5. The fastener assembly of claim 3, wherein the biasing member is at least one magnet.

6. The fastener assembly of claim 1, further including a dowel inserted laterally into the body of the fastener assembly and interfacing with the insert, thereby limiting upward movement of the insert.

7. The fastener assembly of claim 1, wherein the body of the fastener assembly defines a recess that extends a longitudinal length of the body, thereby forming a hollow interior.

8. The fastener assembly of claim 7, wherein the insert interferencingly engages the cutout to limit upward movement along the longitudinal axis.

9. The fastener assembly of claim 8, further comprising:
a lip extending radially from an interior circumference of the cutout for engaging the insert;
a lip extending radially from the insert; and
a plug member.

10. The fastener assembly of claim 9, further including a biasing member positioned between the insert and the plug member when the fastener is assembled.

11. The fastener assembly of claim 1, wherein the body of the fastener assembly comprises two separate halves that fit together around the insert, thereby securing the insert into the fastener assembly.

12. The fastener assembly of claim 11, wherein the insert interferencingly engages the cutout to limit upward movement along the longitudinal axis.

13. The fastener assembly of claim 1, wherein the insert further comprises:
a housing for being fit into the cutout to secure the insert to the head;
a compressible fastener plunger that defines a recess for receiving a working end of a tool;
wherein the compressible fastener plunger is configured for translation within the housing along a longitudinal axis; and
wherein the housing interferencingly engages the compressible fastener plunger to limit upward movement along the longitudinal axis.

14. The fastener assembly of claim 13, wherein the housing engages an outwardly extending shoulder on the compressible fastener plunger to provide interferencing engagement to limit upward movement along the longitudinal axis.

15. The fastener assembly of claim 13, further including a biasing member between the compressible fastener plunger and a surface of the cutout for biasing the compressible fastener plunger in an upward direction relative to the longitudinal axis.

16. The fastener assembly of claim 15, wherein the biasing member is a spring.

17. The fastener assembly of claim 15, wherein the biasing member is at least one magnet.

18. The fastener assembly of claim 1, wherein the insert is constructed from an elastomer-based material.

19. A fastener assembly comprising:
a body comprising a shank having a threaded portion for guiding the fastener assembly into a correspondingly threaded portion of another fastener or a working surface and a head engaged with the shank for receiving a working end of a tool;
wherein the head defines at least one cutout for receiving an insert;
wherein the insert is configured for translation within the cutout along a longitudinal axis;
a biasing member for providing biasing force and translational movement of the insert along the longitudinal axis;
wherein an upward biasing force provided by the biasing member is less than a downward force provided by the working end of the tool;
wherein the insert is depressed inwardly when the working end of the tool is inserted into the cutout, and the insert is biased upwardly when the working end of the tool is removed; and
wherein a top surface of the insert is aligned with a top surface of the fastener assembly when the insert has been biased upwardly.
